(19) United States
(12) Patent Application Publication
(10) Pub. No.: US 2014/0159762 A1
(43) Pub. Date: Jun. 12, 2014

(54) TEST APPARATUS FOR LIQUID CRYSTAL MODULE

(71) Applicants: HEFEI BOE OPTOELECTRONICS TECHNOLOGY CO., LTD, Anhui (CN); BOE TECHNOLOGY GROUP CO., LTD., Beijing (CN)

(72) Inventor: Xiongjian ZHANG, Beijing (CN)

(73) Assignees: HEFEI BOE OPTOELECTRONICS TECHNOLOGY CO., LTD, Anhui (CN); BOE TECHNOLOGY GROUP CO., LTD., Beijing (CN)

(21) Appl. No.: 14/073,306

(22) Filed: Nov. 6, 2013

(30) Foreign Application Priority Data
Dec. 7, 2012 (CN) 201210526472.1

(51) Int. Cl. G09G 3/00

(52) U.S. Cl. CPC G09G 3/006
USPC 324/760.01

(57) ABSTRACT

An embodiment of the present invention provides a test apparatus for a liquid crystal module, comprising: a light up module, being configured for being coupled to the liquid crystal module to be tested for lighting up the liquid crystal module, and providing a test image to the liquid crystal module; a flickering degree obtaining module, being configured for obtaining a flickering degree of the liquid crystal module; a voltage module, being configured for being coupled to the liquid crystal module to be tested, and supplying a voltage to the liquid crystal module; a control module, being respectively coupled to the flickering degree obtaining module and the voltage module, and being configured for controlling the voltage module to output the voltage and receiving the flickering degree of the liquid crystal module in association with the corresponding voltage obtained by the flickering degree obtaining module.

### CROSS REFERENCE OF RELATED APPLICATIONS

The present application claims priority to and incorporates by reference the entire contents of Chinese priority document 201210526472.1, filed in China on Dec. 7, 2012.

### BACKGROUND OF THE INVENTION

1. Field of the Invention

The present invention relates to the field of testing a liquid crystal module, and more particularly to an automatic test apparatus for a liquid crystal module.

2. Description of the Prior Art

A liquid crystal display (LCD) has advantages of light weight, low power, radiation-free, and etc, and thus has been widely used. The flickering of the LCD is caused by the variation generated by the fluctuation of the brightness at a same timeline. Therefore, the flickering degree of the liquid crystal module is required to be tested in advance prior to being shipped.

So far, in designing the conventional panel, the voltage (Vcom) of a fixed common electrode is adopted, and then the voltage of the display electrode continuously varied up and down. Meanwhile, the optimal voltage Vcom displaces under the influence of the feedback voltage. Regarding the flickering display of the liquid crystal module, it is commonly adopted a specialized image for flickering, wherein, conventionally, the voltage Vcom is manually adjusted, and the quality of the flickering is determined by human eyes. The accuracy of such testing solution is not high due to error caused by observation of human eyes.

In the Cited Document 1, it proposes that the Vcom is adjusted by utilizing the external environment information for the purpose of eliminating the flickering of the image. In this technical solution, it significantly depends on the environment, leading to large uncertainties. Furthermore, in this technical solution, it is intuitively determined by the human eyes. As a result, the quantifiable metrics may not be specifically obtained, and the testing deviation is large.

The Cited Document 1: Chinese Patent Application Publication No. 1635403A, published on Jul. 6, 2005.

### SUMMARY OF THE INVENTION

The technical problem to be solved by the present invention lies in that: the flickering degree of the liquid crystal module is conventionally tested by manually adjusting the voltage and observing by human eyes, which has the defect of large error and leads to low accuracy of testing.

For solving the above technical problem, an embodiment of the present invention provides a test apparatus for the liquid crystal module, which may comprise:

a light up module, being configured for being coupled to the liquid crystal module to be tested for lighting up the liquid crystal module, and providing a test image to the liquid crystal module;

a flickering degree obtaining module, being configured for being coupled to the liquid crystal module to be tested for obtaining a flickering degree of the liquid crystal module;

a voltage module, being configured for being coupled to the liquid crystal module to be tested, and supplying a voltage to the liquid crystal module;

a control module, being respectively coupled to the flickering degree obtaining module and the voltage module, and being configured for controlling the voltage module to output the voltage and receiving the flickering degree of the liquid crystal module in association with the corresponding voltage obtained by the flickering degree obtaining module.

In the above test apparatus, the control module may further comprise:

a voltage controlling sub-module, being coupled to the voltage module, and being configured for controlling the voltage module to output the voltage with variation; and

a flickering degree receiving sub-module, being coupled to the flickering degree obtaining module, and being configured for receiving the flickering degree of the liquid crystal module obtained by the flickering degree obtaining module.

In the above test apparatus, the control module may further comprise an output sub-module, being configured for comparing the flickering degrees of the liquid crystal module under different voltages, and outputting the voltage corresponding to the minimum value of the flickering degree.

In the above test apparatus, the control module may further comprise a display sub-module, being configured for establishing a corresponding relation between the voltage outputted by the voltage module and the flickering degree of the liquid crystal module to be tested, and displaying the corresponding relation by a curve.

In the above test apparatus, the voltage outputted by the voltage output module under the control of the voltage controlling sub-module may vary to increase or decrease based on a constant variation value.

In the above test apparatus, the light up module may be a light up device, wherein the flickering image corresponding to the liquid crystal module to be tested is added in the light up device, and the light up device outputs to the liquid crystal module to be tested upon being coupled to the liquid crystal module to be tested.

In the above test apparatus, the voltage module may comprise a programmable voltage source.

In the above test apparatus, the programmable voltage source may be coupled to the control module by a general-purpose interface bus.

In the above test apparatus, the programmable voltage source may be coupled to the control module by a serial communication data line.

In the above test apparatus, the flickering degree obtaining module may be a color analyzer.

In addition, the embodiments of the present invention also provide a test method for a liquid crystal module and a non-transient storage medium storing a program configured to implement the test method.

The above technical solutions of the embodiments of the present invention have the following technical effects: the flickering degree of the liquid crystal module to be tested is obtained by the flickering degree obtaining module by controlling the variation of the voltage of the liquid crystal module to be tested. And the voltage appropriate for the liquid crystal module to be tested may be selected based on the obtained flickering degree. Both obtaining the flickering degree and controlling the voltage are under the intelligent control. And therefore it is accurately determined the optimal value of Vcom to be set corresponding to the optimal flickering value of the liquid crystal module. The flickering degree of the liquid crystal module may be effectively adjusted by such optimal value of Vcom being fed back. In the present invention, a same batch of the flickering values may be tested in batch, which is fed back for designing a knob for adjusting a range of the Vcom, so that the adjustment range may be narrowed. And it can be conveniently and rapidly adjusted to the flickering degree caused by the optimal Vcom.

### BRIEF DESCRIPTION OF THE DRAWINGS

FIG. 1 illustrates a structure block diagram of a test apparatus according to a first embodiment of the present invention;

FIG. 2 illustrates a structure block diagram of a control module according to the first embodiment of the present invention;

FIG. 3 illustrates a structure block diagram of a control module according to a second embodiment of the present invention;

FIG. 4 illustrates a diagram of light path caused by brightness variation in testing a liquid crystal module according to the first embodiment of the present invention; and

FIG. 5 illustrates a curve diagram of a voltage−variation of flickering degree in testing a liquid crystal module according to the first embodiment of the present invention.

### DETAILED DESCRIPTION OF THE PREFERRED EMBODIMENTS

In the following, the explanation will be made in details in association with Figures and specific embodiments to further clarify the technical problems to be solved by the present invention, the technical solutions and the advantages.

As illustrated in FIG. 1, it is the structure diagram of the test apparatus according to the first embodiment of the present invention. The test apparatus of the present embodiment comprises a light up module 100, a flickering degree obtaining module 200, a voltage module 300 and a control module 400. On the other hand, a liquid crystal module 500 is used as a unit to be tested. The light up module 100 is configured for being coupled to the liquid crystal module 500 to be tested, lighting up the liquid crystal module, and inputting a test image. The flickering degree obtaining module 200 is configured for being coupled to the liquid crystal module 500 to be tested, and obtaining a flickering degree of the liquid crystal module. The voltage module 300 is configured for being coupled to the liquid crystal module to be tested, and supplying a voltage to the liquid crystal module. The control module 400 is respectively coupled to the flickering degree obtaining module 200 and the voltage module 300, and is configured for controlling the voltage module to output the voltage and receiving the flickering degree of the liquid crystal module in association with the corresponding voltage obtained by the flickering degree obtaining module. In the embodiments of the present invention, the flickering degree of the liquid crystal module to be tested is obtained by the flickering degree obtaining module by controlling the voltage of the liquid crystal module to be tested. Both obtaining the flickering degree and controlling the voltage are under the intelligent control, and therefore it is accurately determined the optimal set value of Vcom corresponding to the optimal flickering value of the liquid crystal module. The flickering degree of the liquid crystal module may be effectively adjusted by such optimal value of Vcom being fed back, and the voltage appropriate for the liquid crystal module to be tested may be selected based on the obtained flickering degree. In the embodiments of the present invention, a same batch of the flickering values may be tested in batch, which is fed back for designing a knob for adjusting a range of the Vcom, so that the adjustment range may be narrowed. And it can be conveniently and rapidly adjusted to the flickering degree caused by the optimal Vcom.

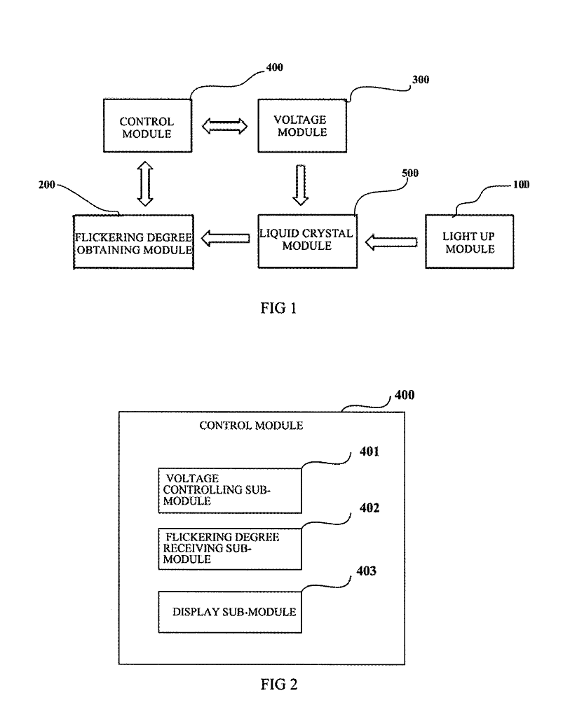

As illustrated in FIG. 2, it is the structure block diagram of the control module according to the first embodiment of the present invention, and the control module 400 in this embodiment further comprises:

a voltage controlling sub-module 401, being configured for being coupled to the voltage module, and controlling the voltage module to output the voltage with variation;

a flickering degree receiving sub-module 402, being configured for being coupled to the flickering degree obtaining module, and receiving the flickering degree of the liquid crystal module obtained by the flickering degree obtaining module;

a display sub-module 403, being configured for establishing a corresponding relation between the voltage outputted by the voltage module and the flickering degree of the liquid crystal module to be tested, and displaying by a curve accordingly.

In the embodiments of the present invention, the voltage controlling sub-module 401 is configured for controlling the voltage module to output the voltage with variation, so that different voltages being inputted into the liquid crystal module are implemented. Thus it may be observed the flickering degrees of the liquid crystal module to be tested which is driven by different voltages. The voltage outputted by the voltage output module under the control of the voltage controlling sub-module 401 may be changed by increasing or decreasing. In the embodiments of the present invention, the display sub-module 403 displays the test voltage and the flickering degree by using a curve, so that it directly reflects a magnitude of the flickering value of the liquid crystal module to be tested under different voltages. A person who implements such a test may quickly select the voltage appropriate for the liquid crystal module to be tested by using the curve, the duration for testing can be significantly reduced, and it is achieved that the liquid crystal modules are tested in batches.

In the embodiments of the present invention, the voltage with variation outputted by the voltage module under the control of the voltage controlling sub-module may be set as required, and the variation value of the output voltage may be also adjusted during testing. Preferably, the voltage outputted by the voltage output module under the control of the voltage controlling sub-module may gradually increase based on a constant variation value. The variation value may be selected as small as possible, for example, a variation of 0.05-0.2 v. And the flickering degree of the liquid crystal module at the corresponding voltage may be obtained by the flickering degree receiving sub-module 402, so that it may test the flickering degree of the liquid crystal module to be tested within a continuous voltage range, so as to find the output voltage corresponding to the minimum flickering degree. Definitely, it is also possible that the output voltage gradually decreases based on a constant variation value. The flickering degree of the liquid crystal module may be also tested alike.

As illustrated in FIG. 5, it is a curve diagram of the voltage−variation of flickering degree in testing the liquid crystal module according to the first embodiment of the present invention. In this embodiment, it is selected that the range of the output voltage is 2.8˜3.2 v, the output voltage starts from 2.8 v and varies to increase by 0.1 v. And the flickering degree of the liquid crystal module corresponding to each variation voltage is obtained by a color analyzer. The input voltage values of the liquid crystal module are on the X-axis, and the flickering degrees are on the Y-axis, so as to establish a corresponding relation therebetween, which is represented by the curve. In this embodiment, the value of Vcom corresponding to the minimum flickering may be easily obtained by the variation curve of the voltage−flickering degree. In the embodiments of the present invention, a same batch of the flickering values may be tested in batch, which is fed back for designing a knob for adjusting a range of the Vcom, so that the adjustment range may be narrowed, and it is conveniently and rapidly adjusted to the flickering degree caused by the optimal Vcom.

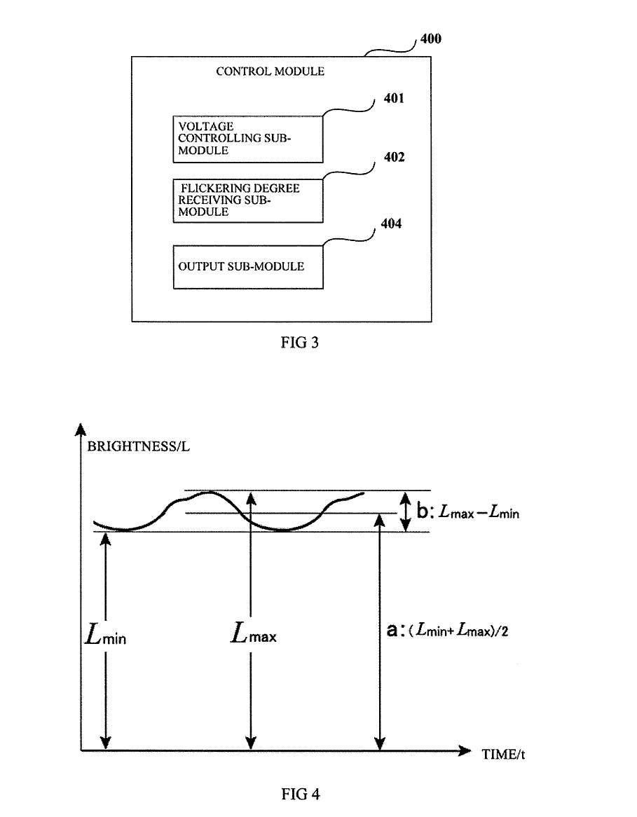

As illustrated in FIG. 3, it is the structure block diagram of the control module according to the second embodiment of the present invention, and the control module 400 in this embodiment further comprises:

a voltage controlling sub-module 401, being configured for being coupled to the voltage module, and controlling the voltage module to output the voltage with variation;

a flickering degree receiving sub-module 402, being configured for being coupled to the flickering degree obtaining module, and receiving the flickering degree of the liquid crystal module obtained by the flickering degree obtaining module; and

an output sub-module 404, being configured for comparing the flickering degrees of the liquid crystal module under different voltages, and outputting the voltage corresponding to the minimum value of the flickering degree.

The control module in this embodiment and the control module in the first embodiment are substantially the same, but different in that the display sub-module is replaced by the output sub-module 404 in the control module of this embodiment. The voltage corresponding to the minimum value of the flickering degree is outputted by comparing the flickering degrees of the liquid crystal module under different voltages. The voltage corresponding to the minimum value of the flickering degree may be directly outputted upon testing the liquid crystal module, and therefore the time is greatly reduced and the test efficiency is improved.

In the embodiments of the present invention, the light up module 100 may be any component that is capable of lighting on the liquid crystal module and inputting the test image to the liquid crystal module. In this embodiment, it is a light up device, wherein the flickering image corresponding to the liquid crystal module to be tested is added to the light up device. Upon being coupled to the liquid crystal module to be tested, the light up device outputs to the liquid crystal module to be tested. The flickering image is used by the liquid crystal module upon implementing specific flickering test. A monitor or TV product adopts a mode of 1+2 dots, while a note book product adopts a mode of 1 line+2 dots. In the embodiments of the present invention, besides the light up device, the light up module may also be a display apparatus being matched with the liquid crystal module to be tested, for example, a notebook computer. Such a notebook computer is required to be of a size corresponding to the liquid crystal module to be tested and have a system matched with the liquid crystal module to be tested, so that the liquid crystal module may be lighted on, and normally display a specific pattern for flickering.

In the embodiments of the present invention, the flickering value obtaining module 200 may be any component that is capable of obtaining the flickering value of the liquid crystal module. In this embodiment, it is adopted the color analyzer which has some probes. It is coupled to the liquid crystal module to be tested by the probes, and the flickering degree of the liquid crystal module is obtained by the probes, which is then delivered to the color analyzer. It is determined the flickering degree of the liquid crystal module based on the maximum brightness and minimum brightness of the test image.

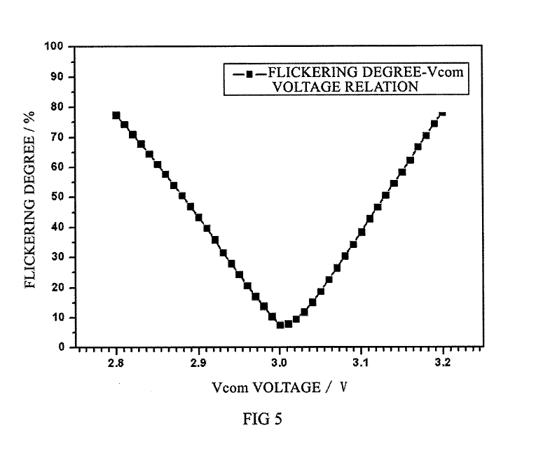

As illustrated in FIG. 4, it is a diagram of the light path caused by brightness variation during testing a liquid crystal module according to the first embodiment of the present invention. The brightness of the liquid crystal module is below the flickering image. The flickering AC variation amount is b, i.e., Lmax−Lmin, and the DC amount is a, i.e., (Lmax+Lmin)/2. The flickering degree of the liquid crystal module to be tested is (b/a)*100%. In the embodiments of the present invention, the VBA assembly language is adopted for programming, the control unit is coupled to the flickering degree obtain unit, and the program unit for obtaining the flickering degree thereof is: “objCa.Measure/Cells(n, 2).value=objProbe.FlckrFMA”.

In the embodiments of the present invention, the voltage module 300 is configured for supplying the voltage to the liquid crystal module, and preferably comprises a programmable voltage source, so that the control of the voltage by computer programming may be implemented. Comparing with manual control of the voltage, the control with more precision may be implemented, and the accuracy of the test may be improved. The programming voltage source is coupled to various control modules such as a computer, a microprocessor, and etc., which may be a connection by the general-purpose interface bus (GPIB) or a connection by the serial communication data line.

In an embodiment of the present invention, the voltage source is coupled to the computer by the GPIB, and conforms to the interface of the IEEE488 standard. In this embodiment, a GPIB data interface card is loaded on the computer, and the voltage source is coupled via the GPIB data interface card. The computer independently controls a magnitude and time interval of the output voltage. Upon testing, the voltage outputted by the voltage source may be used as the Vcom voltage and supplied to the liquid crystal module by tuning the knob for adjusting the Vcom of the liquid crystal module into a state of being turned off. The Vcom voltage only utilizes a common electrode input line being directly coupled to the liquid crystal panel on the printed circuit board (PCB) and does not impose any interference on other circuit signals, so that it does not affect the normal operation of other components on the PCB of the liquid crystal panel. In the embodiments of the present invention, the automatic test is implemented by controlling the variation of the voltage of the liquid crystal module, i.e. enabling the color analyzer to read the flickering degree, and accessing data by the computer. As a result, the deviation of the flickering degree caused by the determination by human eyes is significantly reduced.

In the second embodiment of the present invention, the voltage source is coupled to the computer by the serial communication data line. In the connection of the voltage source, the GPIB card is replaced by the serial communication data line, so that the cost of hardware is reduced. The voltage source communicates with the COM interface of the computer by the serial communication data line. In this embodiment, the programmable voltage source is coupled to the computer by the serial communication data line, and configured for controlling the output voltage of the voltage source. In this embodiment, the VBA assembly language is adopted for programming, while other languages may also be adopted for programming and controlling. When adopting VBA assembly language, the corresponding COM communication program unit is: “PwrSupply.IO.BaudRate=9600/PwrSupply.IO.FlowControl=ASRL_FLOW_DTR_DSR/PwrSupply.WriteString “Syst:Rem”/PwrSupply.WriteString “apply p25V”/PwrSupply.WriteString “Output on”/PwrSupply.WriteString “Volt” & (Cells(n, 1).value)”.

In the above technical solutions, the flickering degree of the liquid crystal module to be tested is obtained by the flickering degree obtaining module by controlling the voltage of the liquid crystal module to be tested. Both obtaining the flickering degree and controlling the voltage are under the intelligent control, and therefore it is accurately determined the optimal value of Vcom to be set corresponding to the optimal flickering value of the liquid crystal module. The flickering degree of the liquid crystal module may be effectively adjusted by such optimal value of Vcom being fed back. In the embodiments of the present invention, a same batch of the flickering values may be tested in batch, which is fed back for designing the knob for adjusting the range of the Vcom, so that the adjustment range may be narrowed, and it is conveniently and rapidly adjusted to the flickering degree caused by the optimal Vcom.

The above descriptions are only preferred embodiments of the present invention. It should be noted that, for those ordinary skilled in the art, many modifications and polishes may be made without departure from the principles of the present invention, and these modification and polishes should also be deemed to be fallen into the protection scope of the present invention.

What is claimed is:

1. A test apparatus for a liquid crystal module, comprising:
a light up module, being configured for being coupled to the liquid crystal module to be tested for lighting up the liquid crystal module, and providing a test image to the liquid crystal module;
a flickering degree obtaining module, being configured for being coupled to the liquid crystal module to be tested for obtaining a flickering degree of the liquid crystal module;
a voltage module, being configured for being coupled to the liquid crystal module to be tested, and supplying a voltage to the liquid crystal module; and
a control module, being respectively coupled to the flickering degree obtaining module and the voltage module, and being configured for controlling the voltage module to output the voltage and receiving the flickering degree of the liquid crystal module in association with the corresponding voltage obtained by the flickering degree obtaining module.

2. The test apparatus according to claim 1, wherein the control module comprises:
a voltage controlling sub-module, being coupled to the voltage module, and being configured for controlling the voltage module to output the voltage with variation; and
a flickering degree receiving sub-module, being coupled to the flickering degree obtaining module, and being configured for receiving the flickering degree of the liquid crystal module obtained by the flickering degree obtaining module.

3. The test apparatus according to claim 2, wherein the control module further comprises an output sub-module, being configured for comparing the flickering degrees of the liquid crystal module under different voltages, and outputting the voltage corresponding to the minimum value of the flickering degree.

4. The test apparatus according to claim 2, wherein the control module further comprises a display sub-module, being configured for establishing a corresponding relation between the voltage outputted by the voltage module and the flickering degree of the liquid crystal module to be tested, and displaying the corresponding relation by a curve.

5. The test apparatus according to claim 2, wherein the voltage outputted by the voltage output module under the control of the voltage controlling sub-module varies to increase or decrease based on a constant variation value.

6. The test apparatus according to claim 1, wherein the light up module is a light up device, wherein the flickering image corresponding to the liquid crystal module to be tested is added in the light up device, and the light up device outputs to the liquid crystal module to be tested upon being coupled to the liquid crystal module to be tested.

7. The test apparatus according to claim 1, wherein the voltage module comprises a programmable voltage source.

8. The test apparatus according to claim 7, wherein the programmable voltage source is coupled to the control module by a general-purpose interface bus.

9. The test apparatus according to claim 7, wherein the programmable voltage source is coupled to the control module by a serial communication data line.

10. The test apparatus according to claim 1, wherein the flickering degree obtaining module is a color analyzer.

11. A test method for a liquid crystal module, comprising:
a light up step, being coupled to the liquid crystal module to be tested for lighting up the liquid crystal module, and providing a test image to the liquid crystal module;
a flickering degree obtaining step, being coupled to the liquid crystal module to be tested for obtaining a flickering degree of the liquid crystal module;
a voltage providing step, being coupled to the liquid crystal module to be tested, and supplying a voltage to the liquid crystal module; and
a control step, controlling the voltage provided by the voltage providing step and receiving the flickering degree of the liquid crystal module in association with the corresponding voltage obtained by the flickering degree obtaining step.

12. The test method according to claim 11, wherein the control step comprises:
controlling the voltage providing step to provide the voltage with variation; and
receiving the flickering degree of the liquid crystal module obtained by the flickering degree obtaining step.

13. The test method according to claim 12, wherein the control step further comprises:
comparing the flickering degrees of the liquid crystal module under different voltages, and outputting the voltage corresponding to the minimum value of the flickering degree.

14. The test method according to claim 12, wherein the control step further comprises:
establishing a corresponding relation between the voltage outputted by the voltage providing step and the flickering degree of the liquid crystal module to be tested, and displaying the corresponding relation by a curve.

15. The test method according to claim 12, wherein the voltage outputted by the voltage providing step varies to increase or decrease based on a constant variation value.

16. The test method according to claim 11, wherein the light up step is conducted by a light up device, and
wherein the flickering image corresponding to the liquid crystal module to be tested is added in the light up device, and the light up device outputs to the liquid crystal module to be tested upon being coupled to the liquid crystal module to be tested.

17. The test method according to claim 11, wherein the voltage providing step is conducted by a programmable voltage source.

18. The test method according to claim 11, wherein the flickering degree obtaining step is conducted by a color analyzer.

19. A non-transient storage medium storing a program configured to implement a test method for a liquid crystal module, wherein the storage medium enables a computer to invoke the program stored in the non-transient storage medium to perform the following steps:
a light up step, being coupled to the liquid crystal module to be tested for lighting up the liquid crystal module, and providing a test image to the liquid crystal module;
a flickering degree obtaining step, being coupled to the liquid crystal module to be tested for obtaining a flickering degree of the liquid crystal module;
a voltage providing step, being coupled to the liquid crystal module to be tested, and supplying a voltage to the liquid crystal module; and
a control step, controlling the voltage provided by the voltage providing step and receiving the flickering degree of the liquid crystal module in association with the corresponding voltage obtained by the flickering degree obtaining step.
